(19) United States
(12) Patent Application Publication
(10) Pub. No.: US 2026/0027554 A1
(43) Pub. Date: Jan. 29, 2026

(54) M/TIO2 CATALYSTS AND METHODS OF USE

(71) Applicant: University of Florida Research Foundation, Inc., Gainesville, FL (US)

(72) Inventors: Wei David Wei, Gainesville, FL (US); Jiawei Huang, Gainesville, FL (US)

(21) Appl. No.: 19/348,976

(22) Filed: Oct. 3, 2025

Related U.S. Application Data
(63) Continuation of application No. 17/917,163, now Pat. No. 12,458,952.
(60) Provisional application No. 63/006,558, filed on Apr. 7, 2020.

(51) Int. Cl. B01J 21/06; B01J 23/52; B01J 35/45; B01J 37/08

(52) U.S. Cl. CPC B01J 21/063; B01J 23/52; B01J 35/45; B01J 37/08

(57) ABSTRACT

The present disclosure provides for methods for designing and constructing metal/semiconductor heterostructures as catalysts for a wide range of applications such as oxygen activation. In a particular aspect, the present disclosure provides for the manipulation of atomic structures at M/TiO₂ interface (e.g., Au/TiO₂ interface) that significantly alters the interfacial electron distribution and prompts O₂ activation. In an aspect, the present disclosure provides for a M/TiO₂ composites (e.g., heterostructures) having a defect-free M/TiO₂ interface and method of making the M/TiO₂ composites having a defect-free M/TiO₂ interface. The M can be Au, Ag, Cu, Al, Pt, Ni, or Pd, for example.

### CLAIM OF PRIORITY TO RELATED APPLICATION

This application is the Continuation of U.S. patent application Ser. No. 17/917,163, filed on Oct. 5, 2022, which is the 35 U.S.C. § 371 national stage of PCT application having serial number PCT/US2021/025984, filed on Apr. 6, 2021, which claims priority to co-pending U.S. provisional application entitled “MANIPULATING ATOMIC STRUCTURES OF AU/TIO2 CATALYSTS FOR EFFICIENT 02 ACTIVATION” having Ser. No. 63/006,558 filed on Apr. 7, 2020, This application claims priority to co-pending U.S. provisional application entitled “M/TIO₂ CATALYSTS AND METHODS OF USE” having Ser. No. 63/028,870 filed on May 22, 2020, which is entirely incorporated herein by reference.

### FEDERAL FUNDING

This invention was made with government support under Grant Nos. 1808539 and DMR-1352328, awarded by the National Science Foundation. The government has certain rights in the invention.

### BACKGROUND

The integration of metal nanoparticles (NPs) with oxides can provide for composite material that can be used as catalysts. However, there is a lack of understanding of the exact functionality of atomic structures at metal/oxide interfaces in governing the catalytic activity and its implications for practical applications. Another limitation is the lack of research directed to constructing distinct atomic structures solely at the metal/oxide interface as opposed to adjusting atomic and electronic structures of whole oxides. The lack of understanding and limitations has prevented progress.

### SUMMARY

The present disclosure provides for M/TiO₂ composites (e.g., heterostructures) having a defect-free M/TiO₂ interface and methods of making the M/TiO₂ composites having a defect-free M/TiO₂ interface.

An aspect of the present disclosure provides for a composition, comprising: a M/TiO₂ composite having a defect-free M/TiO₂ interface, wherein the M/TiO₂ composite has the characteristic of having a higher CO oxidation activity than that on the oxygen vacancy (Vo)-rich M/TiO₂ interface. In an aspect, M can be Au, Ag, Cu, Al, Pt, Ni, or Pd. M/TiO₂ composite can be a Au/TiO₂ composite or Cu/TiO₂ composite, for example.

An aspect of the present disclosure provides for a method comprising: providing a M/TiO₂ composite having an oxygen vacancy (Vo)-rich M/TiO₂ interface; calcinating the M/TiO₂ composite at about 300 to 350° C. for a time frame to form a M/TiO₂ composite having a defect-free M/TiO₂ interface. In an aspect, the time frame is about 1 to 3 hours.

An aspect of the present disclosure provides for a method comprising: heating a mixture of TiO₂ with a metal nanoparticle precursor material to form a solid material comprising a M/TiO₂ composite having an oxygen vacancy (Vo)-rich M/TiO₂ interface; and calcinating the solid material comprising the M/TiO₂ composite at about 300 to 350° C. for a time frame to form a M/TiO₂ composite having a defect-free M/TiO₂ interface. In an aspect, the heating can include heating the mixture at about 300 to 350 K for about 15 to 45 minutes at a pH of about 9-10.

### BRIEF DESCRIPTION OF THE DRAWINGS

Further aspects of the present disclosure will be more readily appreciated upon review of the detailed description of its various embodiments, described below, when taken in conjunction with the accompanying drawings.

FIG. 1.1 illustrates Au/TiO₂ heterostructures with distinct interfaces. Schematic of Au/TiO₂ heterostructures with (FIG. 1.1A) the defect-free interface and (FIG. 1.1B) the Vₒ-rich interface are shown. The yellow, red, and silver dots represent gold, oxygen, and titanium atoms, respectively. The green dot stands for the interfacial Vₒ. High resolution transmission electron microscopy (HRTEM) images of Au/TiO₂ heterostructures with (FIG. 1.1C) the defect-free interface and (FIG. 1.1D) the Vₒ-rich interface.

FIG. 1.2 illustrates electron distributions on Au/TiO₂ heterostructures with distinct interfaces. FIG. 1.2A illustrates high-resolution XPS spectra of the Au 4f orbital for Au/TiO₂ heterostructures with the defect-free interface (red curve) and Au/TiO₂ heterostructures with the Vo-rich interface (blue curve). Note: The energy resolution of XPS spectra is 0.1 eV. Different intensities of Au 4f spectra might come from the non-uniform distribution of Au/TiO₂ heterostructures on the Si wafer during the XPS sample preparation. FIG. 1.2B illustrates X-band EPR spectra of bare TiO₂ NPs (gray curve) and Au/TiO₂ heterostructures with the defect-free interface (red curve) at 90 K. FIG. 1.2C illustrates X-band EPR spectra of bare TiO₂ NPs (gray curve) and Au/TiO₂ heterostructures with the Vo-rich interface (blue curve) at 90 K. Note: EPR comparisons between bare TiO₂ and two Au/TiO₂ heterostructures were carried out using the same amount of samples (ca. 40±2 mg). e⁻(Vₒ) represents electrons trapped at Vₒ on TiO₂ and Ti³⁺ stands for electrons accumulated at Ti centers of rutile TiO₂. The EPR background spectrum has been subtracted from the initial spectra of TiO₂ and two Au/TiO₂ heterostructures.

FIG. 1.3 illustrates in operando DRIFTS for O₂ activation on Au/TiO₂ heterostructures with distinct interfaces. FIG. 1.3A illustrates in operando DRIFTS spectra of v(CO) during O₂ activation on Au/TiO₂ heterostructures with the defect-free interface. v₁(CO)_{O}_{₂} and v₂(CO)_{O}_{₂}, were observed at 2130 cm⁻¹ and 2118 cm⁻¹, respectively. FIG. 1.3B illustrates schematic of O₂ activation on the defect-free Au/TiO₂ interface. The electron transfer from Au NPs into perimeter O₂ molecules resulted in the less electron density within the interfacial Au—CO region than that of area located away from the interface. FIG. 1.3C illustrates in operando DRIFTS spectra of v(CO) during O₂ activation on Au/TiO₂ heterostructures with the Vₒ-rich interface. v₁(CO)_{O}_{₂} and v₂(CO)_{O}_{₂} were observed at 2128 cm⁻¹ and 2116 cm⁻¹, respectively. FIG. 1.3D illustrates schematic of O₂ activation on the Vₒ-rich Au/TiO₂ interface. The interfacial Vₒ trapped electrons and hindered the electron-driven O₂ activation, suppressing interfacial CO oxidation. Note: the resolution of DRIFTS spectra is 2 cm⁻¹ and CO molecules detected in the headspace have been removed from the spectra. Since DRIFTS spectra were collected during the O₂ activation, surface adsorbed CO molecules kept being oxidized by perimeter O₂ molecules, resulting in weak CO vibrational signals.

FIG. 2.1 illustrates schematic of preparing Au/TiO₂ heterostructures with distinct interfaces via deposition-precipitation (DP) and modified colloidal-deposition (CD) methods. FIG. 2.1A illustrates the DP method. HAuCl₄·3H₂O was injected into the TiO₂ solution, followed by the addition of NH₄OH to form Au(OH) 3 species on the TiO₂ surface.¹³ The calcination (210° C. for 3 h) removed surface OH groups and facilitated the diffusion of Au atoms into surface Vₒ, resulting in Au/TiO₂ heterostructures with the defect-free interface. FIG. 2.1B illustrates the CD method. Au NPs at ca. 4-5 nm were first synthesized and then directly mixed with the TiO₂ solution. The diffusion of Au atoms was constrained by the preexisting Au—Au bonding on NPs, leaving Vₒ at the heterogeneous interface.

FIG. 2.2 illustrates high-resolution XPS spectra for Au/TiO₂ and Au/SiO₂ heterostructures. FIG. 2.2A illustrates high-resolution XPS spectrum of the C 1s orbital for Au/TiO₂ heterostructures with the Vₒ-rich interface. FIG. 2.2B illustrates high-resolution XPS spectrum of the Au 4f orbital for Au/SiO₂ heterostructures. The binding energy of Au 4f_{7/2} orbital for Au/SiO₂ heterostructures was 84.0±0.1 eV, indicating the neutral Au on SiO₂.

FIG. 2.3 illustrates simulated X-band EPR spectra. FIG. 2.3A illustrates experimental (black) and simulated (gray) X-band EPR spectra of TiO₂. FIG. 2.3B illustrates experimental (red) and simulated (gray) X-band EPR spectra of Au/TiO₂ heterostructures with the defect-free interface. FIG. 2.3C illustrates experimental (blue) and simulated (gray) X-band EPR spectra of Au/TiO₂ heterostructures with the Vₒ-rich interface. The simulated spectra (gray) are further deconvoluted into various respective components, where e⁻(Vₒ) (pink) represents electrons trapped at Vₒ, rutile Ti³⁺ (orange) is assigned to electrons trapped at Ti³⁺ sites in the rutile phase.^{13,15,16} Note: EPR spectra were collected at 90 K in the dark and the EPR background spectrum was subtracted from the initial spectra.

FIG. 2.4 illustrates schematic of the electron distribution on Au/TiO₂ heterostructures with distinct interfaces. FIG. 2.4A illustrates Au/TiO₂ heterostructures with the defect-free interface, showing the electron transfer pathway from Ti³⁺ species of TiO₂ into Au NPs. FIG. 2.4B illustrates Au/TiO₂ heterostructures with the Vₒ-rich interface, showing that interfacial Vₒ trap electrons from Ti³⁺ species, decreasing the number of electrons into Au NPs. CB and VB represent the conduction band minimum and valence band maximum of TiO₂ NPs, respectively.

FIG. 2.5 illustrates X-band EPR spectra of Au/TiO₂ heterostructures with the defect-free interface prepared by using different amounts of Au. Note: Ti³⁺ stands for electrons accumulated at Ti centers of the rutile TiO₂. EPR spectra were collected at 90 K in the dark and the EPR background spectrum was subtracted from the initial spectra.

FIG. 2.6 illustrates X-band EPR spectra of Au/TiO₂ heterostructures with the Vₒ-rich interface prepared by using different amounts of Au NPs. FIG. 2.6A illustrates TiO₂. No EPR feature from e⁻(Vₒ) was observed. FIG. 2.6B illustrates Au/TiO₂ heterostructures with 0.5 wt % loading amount of Au NPs. The intensity ratio of e⁻(Vₒ)/Ti³⁺ was found to be smaller than 1. FIG. 2.6C illustrates Au/TiO₂ heterostructures with 1.0 wt % loading amount of Au NPs. The intensity ratio of e⁻(Vₒ)/Ti³⁺ was observed to be larger than 1. The variation in the intensity ratio of e⁻(Vₒ)/Ti³⁺ between 0.5 wt % and 1.0 wt % Au loading amount revealed that increasing the loading amount of Au NPs gave a rise in the EPR feature of e⁻(Vₒ), confirming that Vₒ should be located at the heterogeneous interface. Note: e⁻(Vₒ) represents electrons trapped at Vₒ and Ti³⁺ stands for electrons accumulated at Ti centers of rutile TiO₂. EPR spectra were collected at 90 K in the dark and the EPR background spectrum was subtracted from the initial spectra.

FIG. 2.7 illustrates vibrational mode of carbon monoxide molecules v(CO) on Au/TiO₂ heterostructures in the absence of perimeter O₂ molecules (before O₂ activation). FIG. 2.7A illustrates v(CO) for Au/TiO₂ heterostructures with the defect-free interface under 1% CO/He condition, where v(CO) was observed at 2103 cm⁻¹. FIG. 2.7B illustrates schematic of CO molecules adsorbed on Au/TiO₂ heterostructures with the defect-free interface. Electrons transferred from TiO₂ into Au uniformly distributed on the Au surface, increasing the electron density within the Au—CO region. FIG. 2.7C illustrates v(CO) for Au/TiO₂ heterostructures with the Vₒ-rich interface under 1% CO/He condition, where v(CO) was found at 2107 cm⁻¹. FIG. 2.7D illustrates schematic of CO molecules adsorbed on Au/TiO₂ heterostructures with the Vₒ-rich interface. Interfacial Vₒ suppressed electrons from transferring into Au, reducing the electron density within the Au—CO region. Note: the resolution of DRIFTS spectra is 2 cm⁻¹ and CO molecules detected in the headspace were subtracted from the DRIFTS spectra.

FIG. 2.8 illustrates DFT study of the charge variation in Au atoms after the adsorption of O₂ molecules at the perimeter of Au/TiO₂ heterostructures with the defect-free interface. The charge variation in Au atoms (Δ charge after O₂ adsorption) was obtained from the subtraction of charge of Au atoms before O₂ adsorption from that of Au atoms after the O₂ adsorption at the perimeter. The interfacial Au atoms (i.e., Au₁₉, Au₂₁, Au₂₃, and Au₁₂₁) near perimeter O₂ molecules became more positively charged than Au atoms away from the interface. Meanwhile, the charge of O₂ molecules changed from 0 (before adsorption) to −0.55 and −0.38 after the adsorption at the perimeter.

FIG. 2.9 illustrates DFT study of the charge variation in Au atoms after the adsorption of O₂ molecules at the perimeter of Au/TiO₂ heterostructures with the Vₒ-rich interface. The charge variation in Au atoms (Δ charge after O₂ adsorption) was obtained from the subtraction of charge of Au atoms before O₂ adsorption from that of Au atoms after the O₂ adsorption at the perimeter. Interfacial Au atoms (i.e., Au₁₉, Au₂₁ and Au₂₃) near perimeter O₂ molecules became more positively charged than Au atoms away from the interface. However, the sum of charge variations for interfacial Au atoms on the Vₒ-rich interface (i.e., +0.32) was smaller than that on the defect-free interface (i.e., +0.37), demonstrating that fewer electrons transferred from Au NPs into perimeter O₂ molecules at the Vₒ-rich interface.

FIG. 2.10 illustrates CO oxidation on Au/TiO₂ heterostructures with distinct interfaces. FIG. 2.10A illustrates the activation barrier of CO oxidation on Au/TiO₂ heterostructures with distinct interfaces. The activation barrier of CO oxidation on Au/TiO₂ heterostructures with the Vₒ-rich interface was measured to be 34.6±2.7 KJ/mol, while the activation barrier of CO oxidation on Au/TiO₂ heterostructures with the defect-free interface was 12.6±1.9 KJ/mol. FIG. 2.10B illustrates the conversion of CO to CO₂ on Au/TiO₂ heterostructures with the Vₒ-rich interface and the defect-free interface at room temperature. The activity of CO oxidation on Au/TiO₂ heterostructures with the defect-free interface exhibited a ca. 34 times higher CO oxidation activity than that on Au/TiO₂ heterostructures with the Vₒ-rich interface.

FIG. 2.11 illustrates X-band EPR spectra of Au/TiO₂ heterostructures with the Vₒ-rich interface after the calcination under 320° C. FIG. 2.11A illustrates EPR spectrum of Au/TiO₂ heterostructures with the Vₒ-rich interface before the 320° C. calcination. FIG. 2.11B illustrates EPR spectrum of Au/TiO₂ heterostructures with the Vₒ-rich interface after the 320° C. calcination. A decrease in the ratio of e⁻(Vₒ)/Ti³⁺ was observed after the 320° C. calcination, revealing that this high temperature calcination removed interfacial Vₒ and released electrons. Note: e⁻(Vₒ) represents electrons trapped at Vₒ and Ti³⁺ stands for electrons accumulated at Ti centers of rutile TiO₂. EPR spectra were collected at 90 K in the dark and the EPR background spectrum was subtracted from the initial spectra.

FIG. 2.12 illustrates CO oxidation on Au/TiO₂ heterostructures with the Vₒ-rich interface. The activity of CO oxidation after the calcination at 320° C. was 18.5 times higher than that on as-prepared Au/TiO₂ heterostructures with the Vₒ-rich interface.

FIG. 2.13 illustrates TEM images of two Au/TiO₂ heterostructures. FIG. 2.13A illustrates Au/TiO₂ heterostructures with the defect-free interface. The average size of Au NPs was 4.3±0.7 nm. FIG. 2.13B illustrates Au/TiO₂ heterostructures with the Vₒ-rich interface. The average size of Au NPs was 5.0±0.9 nm. The similar size distribution of Au NPs on two Au/TiO₂ heterostructures excluded the size effect from influencing the activity of CO oxidation.

### DETAILED DESCRIPTION

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Embodiments of the present disclosure will employ, unless otherwise indicated, techniques of chemistry, materials science, mechanical engineering, and the like, which are within the skill of the art.

The following examples are put forth so as to provide those of ordinary skill in the art with a complete disclosure and description of how to perform the methods and use the probes disclosed and claimed herein. Efforts have been made to ensure accuracy with respect to numbers (e.g., amounts, temperature, etc.), but some errors and deviations should be accounted for. Unless indicated otherwise, parts are parts by volume, temperature is in ° C., and pressure is at or near atmospheric. Standard temperature and pressure are defined as 20° C. and 1 atmosphere.

Before the embodiments of the present disclosure are described in detail, it is to be understood that, unless otherwise indicated, the present disclosure is not limited to particular materials, reagents, reaction materials, manufacturing processes, or the like, as such can vary. It is also to be understood that the terminology used herein is for purposes of describing particular embodiments only, and is not intended to be limiting. It is also possible in the present disclosure that steps can be executed in different sequences where this is logically possible.

It must be noted that, as used in the specification and the appended claims, the singular forms “a,” “an,” and “the” include plural referents unless the context clearly dictates otherwise. Thus, for example, reference to “a compound” includes a plurality of compounds. In this specification and in the claims that follow, reference will be made to a number of terms that shall be defined to have the following meanings unless a contrary intention is apparent.

### DISCUSSION

In accordance with the purpose(s) of the present disclosure, embodiments of the present disclosure provide for a M/TiO₂ composite (e.g., M/TiO₂ heterostructures) having a defect-free M/TiO₂ interface and method of making the M/TiO₂ composite having a defect-free M/TiO₂ interface.

The present disclosure provides for methods for designing and constructing metal/semiconductor heterostructures as catalysts for a wide range of applications such as oxygen activation. In a particular aspect, the present disclosure provides for the manipulation of atomic structures at M/TiO₂ interface (e.g., Au/TiO₂ interface) that significantly alters the interfacial electron distribution and prompts O₂ activation. As described in more detail in Example 1, at the defect-free Au/TiO₂ interface, electrons transfer from Ti³⁺ species into Au nanoparticles (NPs) and further migrate into adsorbed perimeter O₂ molecules (i.e., in the form of Au—O—O—Ti), facilitating O₂ activation and leading to a higher CO oxidation activity than that on the oxygen vacancy (Vₒ)-rich Au/TiO₂ interface, at which electrons from Ti³⁺ species are trapped by interfacial Vₒ on TiO₂ and hardly interact with perimeter O₂ molecules. Other metals can be used in place of Au, such as Ag and Cu as well as other metals with similar properties as they relate to this disclosure.

The M/TiO₂ composite has shown the capability of driving water-gas shift reactions, CO oxidation, and photocatalytic water oxidation reactions. For instance, the Ni/TiO₂ composite enabled the efficient transformation of CO and H₂O into CO₂ and H₂ in the water-gas shift reaction, during which the interfacial Ni^{δ-}-oxygen vacancy-Ti³⁺ structure functioned as reaction sites to dissociate H₂O into H₂ and O adatom (J. Am. Chem. Soc. 2018, 140, 11241-11251). The O adatom further occupied the interfacial oxygen vacancy, followed by oxidizing adsorbed interfacial CO to produce CO₂. Additionally, the Au/TiO₂ composite has been widely utilized as catalysts in CO oxidation. The construction of Au/TiO₂ interface significantly promoted the adsorption of O₂ molecules (i.e., in the form of Au—O—O—Ti), facilitating the O₂ activation and leading to the CO oxidation (J. Am. Chem. Soc. 2012, 134, 12717-12723). The Au/TiO₂ composite also exhibited the photocatalytic activity of oxidizing water to produce O₂ molecules. Under visible-light irradiation, surface plasmon resonance was induced on Au NPs, resulting in the generation of energetic carriers (hot electrons and hot holes) (J. Am. Chem. Soc. 2017, 139, 11771-11778). These plasmon-generated hot holes (h⁺) in Au NPs were accumulated at the Au/TiO₂ interface under the steady-state condition and were able to oxidize water to produce O₂ (H₂O+h⁺→O₂+4H⁺).

The present disclosure provides for a composition that includes a M/TiO₂ composite having a defect-free M/TiO₂ interface. M can be Au, Ag, Al, Cu, Pt, Ni, or Pd. The M/TiO₂ composite has a characteristic of having a higher CO oxidation activity than that on the oxygen vacancy (Vₒ)-rich M/TiO₂ interface. In particular, the M/TiO₂ composite has a characteristic of having a higher (e.g., at least 10 times, at least 15 times, at least 20 times, at least 25 times, at least 30 times, or at least 34 times) CO oxidation activity than that on the oxygen vacancy (Vₒ)-rich Au/TiO₂ interface. When the M/TiO₂ composite is a Au/TiO₂ composite, the Au/TiO₂ composite has a characteristic of having a higher (e.g., at least 10 times, at least 15 times, at least 20 times, at least 25 times, at least 30 times, or at least 34 times) CO oxidation activity than that on the oxygen vacancy (Vₒ)-rich Au/TiO₂ interface. The M/TiO₂ composite can have a longest dimension (e.g., diameter, length, width, etc.) of about 10 to 50 nm, about 10 to 35 nm, about 10 to 30 nm, about 15 to 30 nm, about 15 to 35 nm, about 20 to 35 nm, about 25 to 35 nm, about 20 to 30 nm, about 20 to 28 nm, or about 23 to 27 nm, where the longest dimension will depend upon at least the M and TiO₂ selected.

While the method of making is provided here, additional details are provided in Example. The method of making the composition that includes the M/TiO₂ composite having the defect-free M/TiO₂ interface can include heating a mixture of TiO₂ (e.g., Degussa P25) with a metal nanoparticle precursor material (e.g., HAuCl₄ for Au). The mixture can be heated at about 300 to 350 K or about 323 K for a time frame of about 15 to 45 minutes or about 30 minutes. The mixture, a solution, can then have it's pH modified to 9 to 10 using a base (e.g., ammonium hydroxide). The mixture can be further heated at about 300 to 350 K or about 323 K for a time frame of about 3 to 5 hours or about 4 hours to form a solid material comprising a M/TiO₂ composite having an oxygen vacancy (Vₒ)-rich M/TiO₂ interface. The solid is separated, washed, and dried prior to calcinating the M/TiO₂ composite (a powder at this stage) at about 300 to 350° C. for a time frame to form a M/TiO₂ composite having a defect-free M/TiO₂ interface. The powder can be formed into a layer, into larger particles (e.g., nanometer to micrometer scales), disposed (e.g., chemically or mechanical attached) on a substrate, or the like and used as desired.

### EXAMPLES

Now having described the embodiments of the present disclosure, in general, example 1 describes some additional embodiments of the present disclosure. While embodiments of the present disclosure are described in connection with example 1 and the corresponding text and figures, there is no intent to limit embodiments of the present disclosure to these descriptions. On the contrary, the intent is to cover all alternatives, modifications, and equivalents included within the spirit and scope of embodiments of the present disclosure.

### Example 1

The integration of metal nanoparticles (NPs) with oxides offers unique opportunities for driving catalytic reactions as compared to their catalytically inaccessible single-component counterparts.¹⁻¹⁶ However, an understanding of the exact functionality of atomic structures at metal/oxide interfaces in governing the catalytic activity and its implications for practical applications has not yet been established.^{17,18} For instance, interfacial atomic structures of Au/TiO₂ heterostructures are complicated when Au is nucleated at surface defects with various coordinated structures of different facets, surface structures, and grain boundaries of TiO₂ NPs.¹⁹⁻²¹ Another major limitation is the lack of strategies for constructing distinct atomic structures solely at the metal/oxide interface rather than adjusting atomic and electronic structures of whole oxides,^{22,23} making it challenging to correlate the interfacial-structure-dependent electron distribution with the catalytic activity.

In this example, we reported how interfacial atomic structures of metal/oxide were manipulated to alter the electron distribution and promote O₂ activation for CO oxidation. Using different fabrication strategies, we successfully fabricated two Au/TiO₂ heterostructures with distinct interfaces and revealed that for the defect-free Au/TiO₂ interface, electrons originated from Ti³⁺ species were transferred from TiO₂ into Au NPs, while those electrons were trapped at Vₒ on TiO₂ at the Vₒ-rich interface. Further investigations showed that such divergent electron distributions on Au/TiO₂ heterostructures resulted in significantly different efficiencies for electron-driven O₂ activation. For Au/TiO₂ with the defect-free interface, electrons that transferred from Ti³⁺ species into Au NPs further migrated to O₂ molecules adsorbed on the perimeter (i.e., in the form of Au—O—O—Ti) to promote O₂ activation. This led to a ca. 34 times higher CO oxidation than that on Au/TiO₂ with the Vₒ-rich interface, where electrons were mainly trapped at interfacial Vₒ on TiO₂ and inhibited from interacting with perimeter O₂ molecules. Moreover, we discovered that calcination at 320° C. significantly decreased the amount of Vₒ at the Vₒ-rich Au/TiO₂ interface, releasing electrons initially trapped at the interfacial Vₒ on TiO₂ for improving the efficiency of O₂ activation.

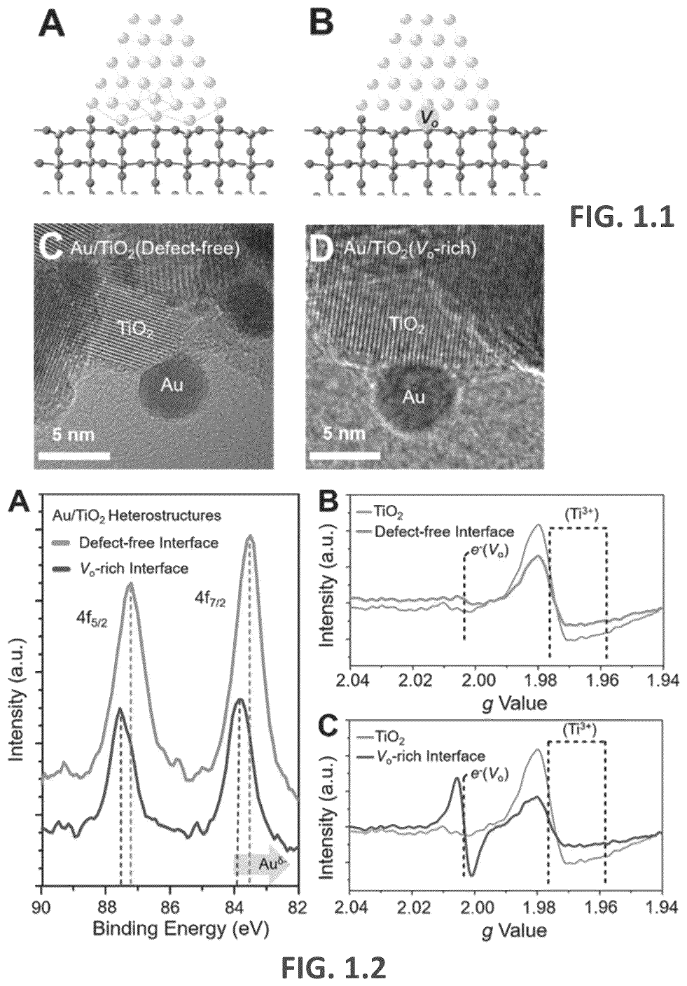

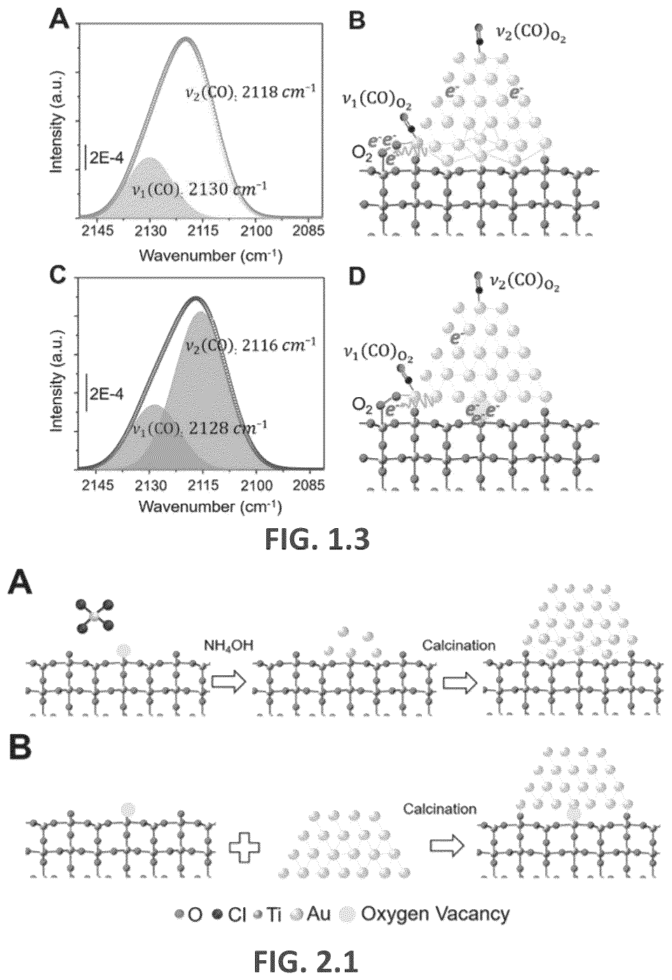

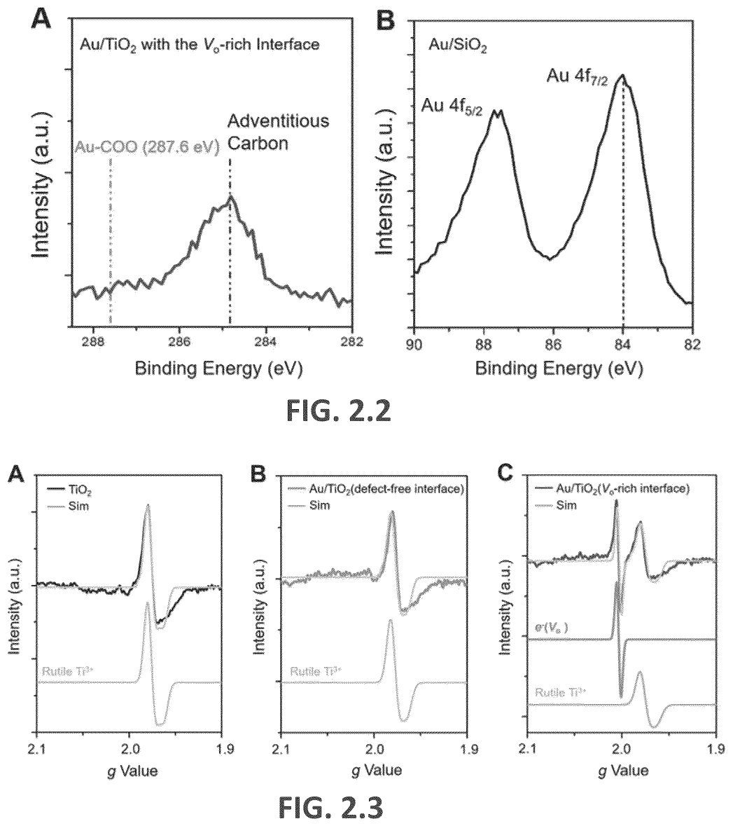

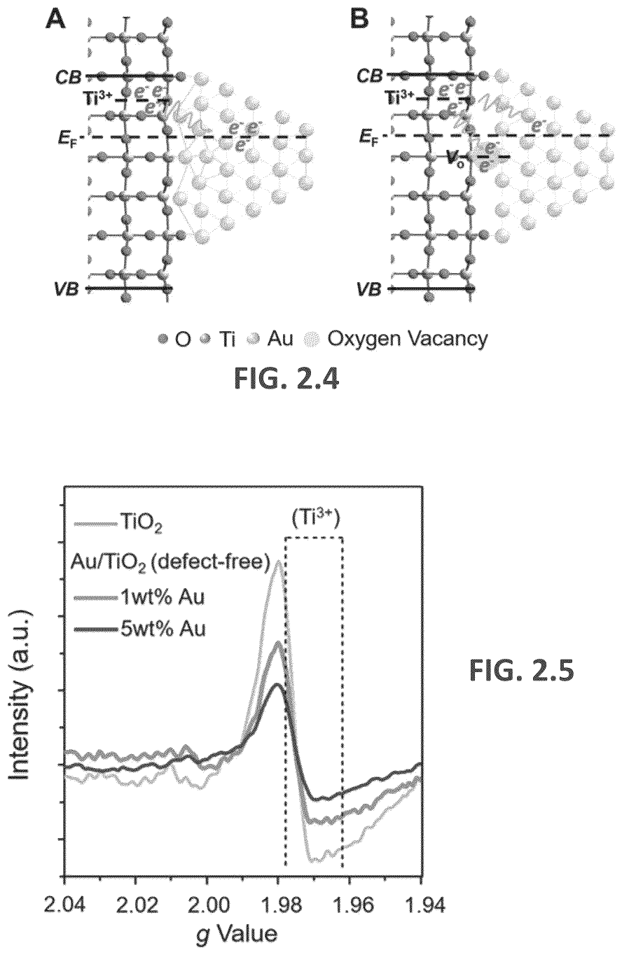

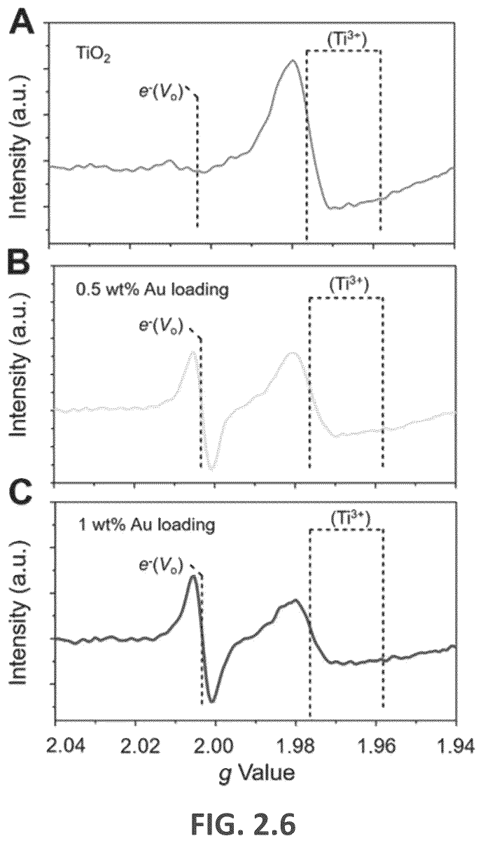

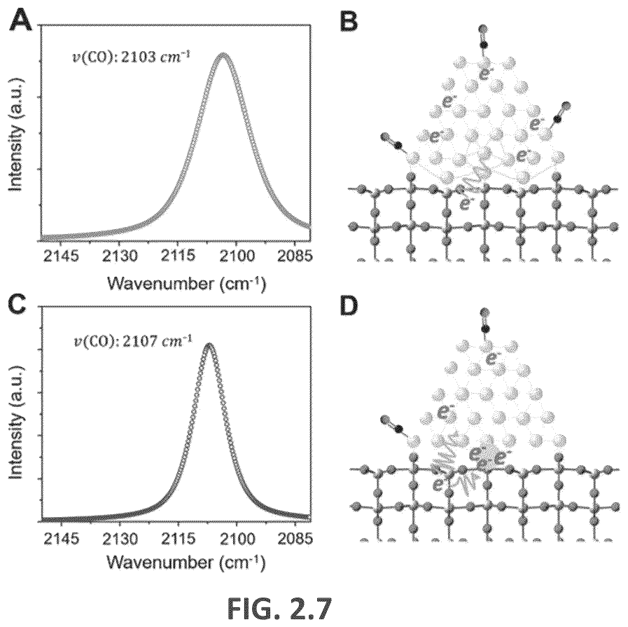

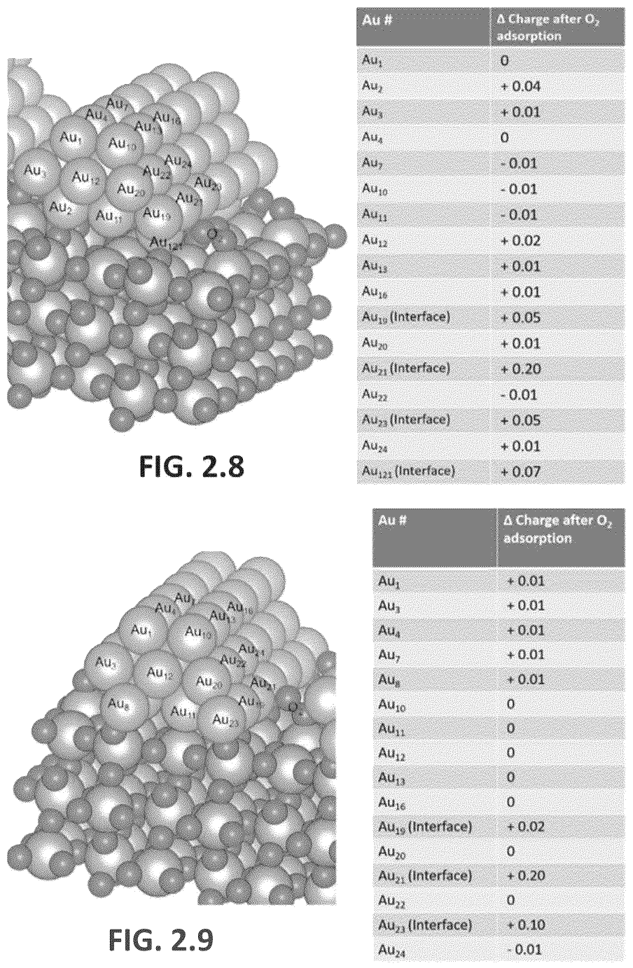

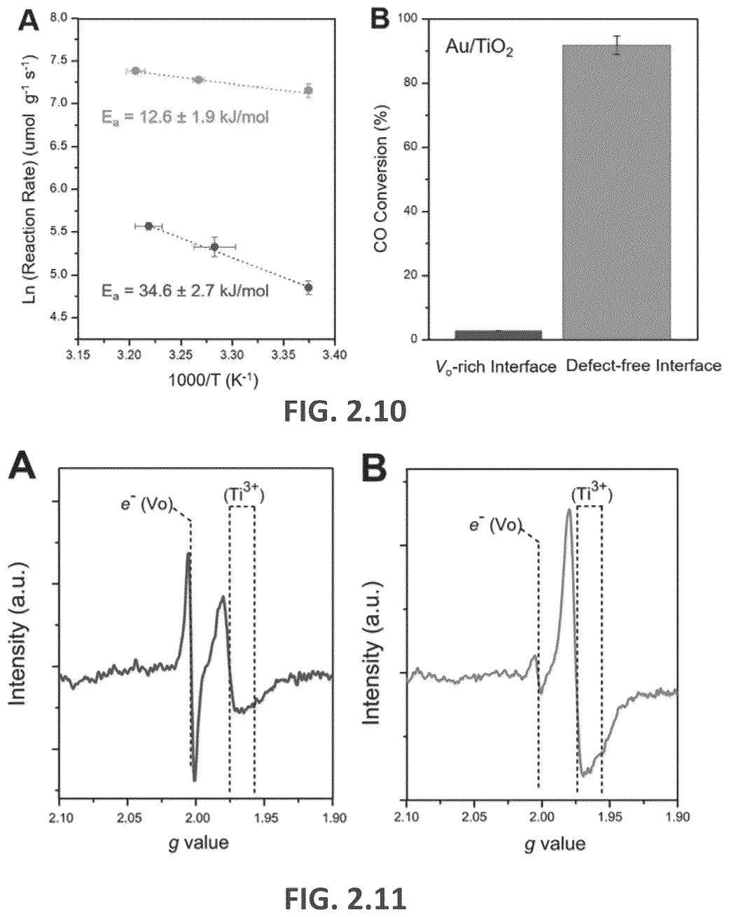

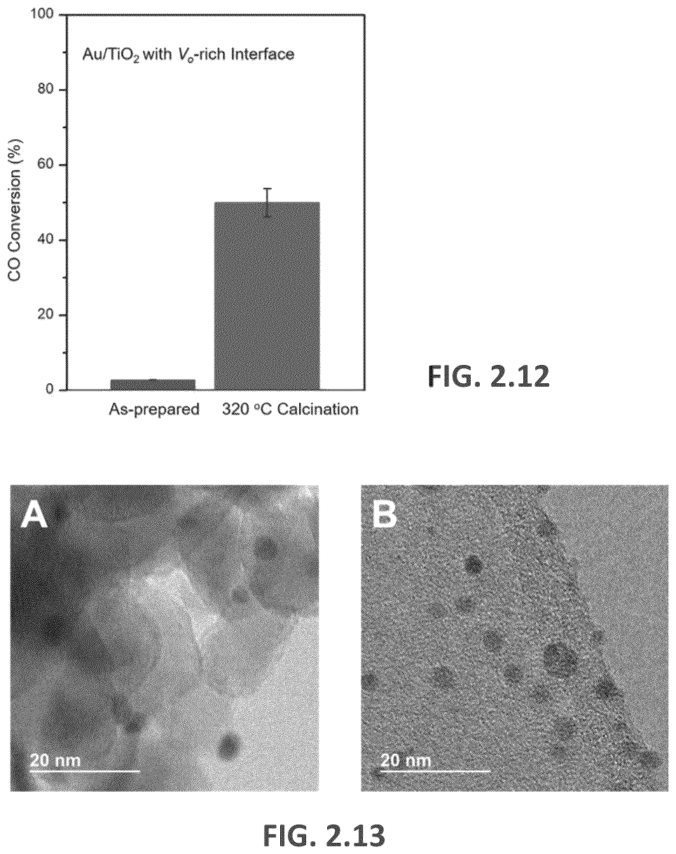

Two Au/TiO₂ heterostructures, with defect-free interface and Vₒ-rich interface, were prepared (FIGS. 1.1A and 1.1B). Using the deposition-precipitation (DP) method,²⁴ chloroauric acid trihydrate (HAuCl_{4.3}H₂O) was directly reduced on the surface of TiO₂ NPs. The diffusion of Au atoms into surface Vₒ on TiO₂ mediated the formation of chemical bonds with Ti atoms²² and developed a defect-free interface (FIG. 2.1A). Meanwhile, through a modified colloidal-deposition (CD) method,²⁵ pre-synthesized Au NPs were directly deposited onto TiO₂ NPs, maintaining Vₒ at the Au/TiO₂ interface (FIG. 2.1B). X-ray photoelectron spectroscopy (XPS) proved that no observable citrate ions remained on Au NPs in Au/TiO₂ heterostructures with the Vₒ-rich interface (FIG. 2.2A). It is noted that with the exception of different atomic structures, both defect-free and Vₒ-rich Au/TiO₂ interfaces contained well-defined nanoscale physical contacts to ensure the interfacial electron transfer (FIGS. 1.1C and 1.1D).^{24,26,27}

When compared to Au/SiO₂ heterostructures (i.e., 84.0±0.1 eV in FIG. 2.2B), high-resolution XPS showed that the Au 4f_{7/2} of both Au/TiO₂ heterostructures shifted to the lower binding energies (FIG. 1.2A: 83.6±0.1 eV for the defect-free interface and 83.8±0.1 eV for the Vₒ-rich interface). This indicated that electrons transferred from TiO₂ into Au NPs via the heterogeneous interface. Moreover, the more lower binding energy of Au 4f_{7/2} (i.e., 83.6±0.1 eV) strongly suggested that more electrons were transferred from TiO₂ to Au for Au/TiO₂ heterostructures with the defect-free interface.

Distinct electron distributions between those two Au/TiO₂ heterostructures were further verified using X-band electron paramagnetic resonance (EPR) spectroscopy. Compared to bare TiO₂ NPs, the EPR feature of electrons accumulated at Ti centers (i.e., Ti³⁺ species) 28-30 significantly decreased on Au/TiO₂ heterostructures with the defect-free interface (FIG. 1.2B and FIGS. 2.3A and 2.3B), suggesting that electrons transferred from Ti³⁺ species of TiO₂ into Au NPs (i.e., EPR silent) (FIG. 2.4A). Additionally, no Vₒ-related EPR feature was observed at the defect-free Au/TiO₂ interface even with 5 wt. % Au (FIG. 2.5), demonstrating that the addition of Au NPs on TiO₂ did not affect the distribution of Vₒ in TiO₂ to influence the electron distribution at the defect-free Au/TiO₂ interface. For Au/TiO₂ heterostructures with the Vₒ-rich interface, despite the observation of a similar decrease of Ti³⁺ species, a new EPR feature (g=2.003) appeared and was assigned to electrons trapped at Vₒ of TiO₂ (FIG. 1.2C, blue curve and FIG. 2.3C).²⁸⁻³⁰ Interestingly, the intensity of this EPR feature continued to rise when the Au NP loading was increased (FIG. 2.6), confirming that those Vₒ must place exactly at the Au/TiO₂ interface. Thus, electrons originally from Ti³⁺ species would be trapped at the interfacial Vₒ of TiO₂ rather than transferring into Au NPs (FIG. 2.4B).

The electron distribution at Au/TiO₂ interface has been reported to determine the activation of perimeter O₂ molecules, in which negatively charged Au NPs induced by the interfacial electron transfer from TiO₂ to Au exhibit a higher O₂ activation efficiency than that on neutral Au NPs.^{5,31,32} Meanwhile, it is known that the vibrational mode of adsorbed carbon monoxide molecules v(CO) is sensitive to the change of electron density of Au NPs,^{33,34} making CO an ideal molecular probe to spectroscopically study the electron-distribution-dependent O₂ activation on those two Au/TiO₂ heterostructures in operando.

For Au/TiO₂ heterostructures with the defect-free interface, two vibrational signatures were observed during O₂ activation (FIG. 1.3A) that were distinct from the mode observed for adsorbed CO before O₂ activation (i.e., 2103±2 cm⁻¹ in FIGS. 2.7A and 2.7B). Interestingly, both CO vibrational modes blue-shifted (v₁(CO)_{O}_{₂}=2130±2 cm⁻¹ and v₂(CO)_{O}_{₂}=2118±2 cm⁻¹), suggesting a decrease of electron density on Au NPs during O₂ activation as the reduced electron density on Au weakened the Au—CO π-back-bonding.^{33.35} Furthermore, density functional theory (DFT) calculations found that during O₂ activation, interfacial Au atoms near perimeter O₂ molecules were more electron-deficient than those away from the interface (FIG. 2.8). Accordingly, we assigned v₁(CO)_{O}_{₂} to CO molecules adsorbed at the Au/TiO₂ perimeter and v₂(CO)_{O}_{₂} to CO molecules adsorbed on Au atoms away from the interface (FIG. 1.3B). DFT calculations confirmed that once the electron density on Au NPs decreased, perimeter O₂ molecules became negatively charged (FIG. 2.8), suggesting that electrons were transferred from Au NPs into perimeter O₂ molecules for O₂ activation (FIG. 1.3B).

Vibrational modes of adsorbed CO molecules on Au/TiO₂ heterostructures with the Vₒ-rich interface (v₁(CO)_{O}_{₂}=2128±2 cm⁻¹ and v₂(CO)_{O}_{₂}=2116±2 cm⁻¹ in FIG. 1.3C) were also found to blue-shift during O₂ activation compared to signals observed before O₂ activation (i.e., 2107±2 cm⁻¹ in FIGS. 2.7C and 2.7D). However, blue-shifts of both vibrational modes were less than those on Au/TiO₂ heterostructures with the defect-free interface, suggesting that fewer electrons were transferred from Au NPs into perimeter O₂ molecules on the Vₒ-rich Au/TiO₂ interface. Further DFT calculations showed less of a decrease of electron density on the Au surface (FIG. 2.9). This observation is consistent with that demonstrated in our XPS and EPR measurements of Au/TiO₂ heterostructures with the Vₒ-rich interface (FIGS. 1.2A and C): electrons were trapped at the interfacial Vₒ and, consequently, were hardly transferred into perimeter O₂ molecules (FIG. 1.3D).

Different amounts of interfacial electrons transferred into perimeter O₂ molecules on these two Au/TiO₂ heterostructures led to discrete efficiencies for O₂ activation, which is the rate-determining step in CO oxidation.^{6.36.37} As shown in FIG. 2.10A, the activation barrier of CO oxidation on Au/TiO₂ heterostructures with the defect-free interface (12.6±1.9 KJ/mol) was much smaller than that on Au/TiO₂ heterostructures with the Vₒ-rich interface (34.6±2.7 KJ/mol). This result confirmed that more electrons migrated from Au into perimeter O₂ molecules on the defect-free interface and significantly facilitated O₂ activation, eventually leading to a ca. 34 times higher activity of CO oxidation than that on Au/TiO₂ heterostructures with the Vₒ-rich interface (FIG. 2.10B).

High temperature calcination has been used to reconstruct interfacial atomic structures between metal NPs and oxides.^{38,39} FIG. 2.11 showed that, after treating Au/TiO₂ heterostructures with the Vₒ-rich interface at 320° C. for 3 hours, calcination significantly decreased the amount of interfacial Vₒ, suggesting that electrons were released from interfacial Vₒ into perimeter O₂ molecules to promote O₂ activation for CO oxidation. Indeed, we observed a ca. 18.5 times higher activity of CO oxidation after the calcination (FIG. 2.12).

In summary, we have successfully manipulated atomic structures at the Au/TiO₂ interface to alter the interfacial electron distribution and promote the catalytic activity. Compared to the Vₒ-rich interface, Au/TiO₂ heterostructures with the defect-free interface showed significantly higher efficiency for O₂ activation. Spectroscopic studies revealed that the defect-free interface permitted the electron transfer from TiO₂ into Au NPs to activate adsorbed perimeter O₂ molecules. By contrast, the Vₒ-rich interface trapped electrons at Vₒ on TiO₂ and prevented electrons from interacting with perimeter O₂ molecules. Moreover, we found that calcination significantly decreased the amount of interfacial Vₒ at the Vₒ-rich Au/TiO₂ interface and released electrons from interfacial Vₒ to promote O₂ activation, further illustrating the importance of manipulating interfacial atomic structures in facilitating heterogeneous catalysis. Taken together, our results not only establish an atomic-level understanding of the interfacial-structure-dependent catalytic activity on Au/TiO₂ heterostructures, but also provide strategies to engineer metal/oxide interfaces for optimizing heterogeneous catalysis.

### REFERENCES FOR EXAMPLE 1

(1) Haruta, M.; Tsubota, S.; Kobayashi, T.; Kageyama, H.; Genet, M. J.; Delmon, B. Low-temperature oxidation of CO over gold supported on TiO₂, α-Fe₂O₃, and Co₃O₄. J. Catal. 1993, 144, 175-192.
(2) Schubert, M. M.; Hackenberg, S.; Van Veen, A. C.; Muhler, M.; Plzak, V.; Behm, J. J. CO oxidation over supported gold catalysts-“Inert” and ‘active’ support materials and their role for the oxygen supply during reaction. J. Catal. 2001, 197, 113-122.
(3) Chen, M.; Goodman, D. W. Catalytically active gold: From nanoparticles to ultrathin films. Acc. Chem. Res. 2006, 39, 739-746.
(4) Cargnello, M.; Doan-nguyen, V. V. T.; Gordon, T. R.; Diaz, R. E.; Stach, E. A.; Gorte, R. J.; Fornasiero, P.; Murray, C. B. Control of Metal Nanocrystal Size Reveals Metal-Support Interface Role for Ceria Catalysts. Science 2013, 341, 771-774.
(5) Min, B. K.; Friend, C. M. Heterogeneous gold-based catalysis for green chemistry: Low-temperature CO oxidation and propene oxidation. Chem. Rev. 2007, 107, 2709-2724.
(6) Green, I. X.; Tang, W.; Neurock, M.; Yates, J. T. Insights into catalytic oxidation at the Au/TiO₂ dual perimeter sites. Acc. Chem. Res. 2014, 47, 805-815.
(7) Chen, M.; Cai, Y.; Yan, Z.; Goodman, D. W. On the origin of the unique properties of supported Au nanoparticles. J. Am. Chem. Soc. 2006, 128, 6341-6346.
(8) Goodman, M. S. C.; D. W. The Structure of Catalytically. Science 2004, 306, 252-255.
(9) Vajda, S.; White, M. G. Catalysis Applications of Size-Selected Cluster Deposition. ACS Catal. 2015, 5, 7152-7176.
(10) DeRita, L.; Resasco, J.; Dai, S.; Boubnov, A.; Thang, H. V.; Hoffman, A. S.; Ro, I.; Graham, G. W.; Bare, S. R.; Pacchioni, G.; Pan, X.; Christopher, P. Structural evolution of atomically dispersed Pt catalysts dictates reactivity. Nat. Mater. 2019, 18, 746-751.
(11) Hemmingson, S. L.; Campbell, C. T. Trends in Adhesion Energies of Metal Nanoparticles on Oxide Surfaces: Understanding Support Effects in Catalysis and Nanotechnology. ACS Nano 2017, 11, 1196-1203.
(12) Li, D.; Chen, S.; You, R.; Liu, Y.; Yang, M.; Cao, T.; Qian, K.; Zhang, Z.; Tian, J.; Huang, W. Titania-morphology-dependent dual-perimeter-sites catalysis by Au/TiO₂ catalysts in low-temperature CO oxidation. J. Catal. 2018, 368, 163-171.
(13) Li, X.; Yang, X.; Huang, Y.; Zhang, T.; Liu, B. Supported Noble-Metal Single Atoms for Heterogeneous Catalysis. Adv. Mater. 2019, 1902031.
(14) Liu, L.; Corma, A. Metal Catalysts for Heterogeneous Catalysis: From Single Atoms to Nanoclusters and Nanoparticles. Chem. Rev. 2018, 118, 4981-5079.
(15) Polo-Garzon, F.; Fung, V.; Nguyen, L.; Tang, Y.; Tao, F.; Cheng, Y.; Daemen, L. L.; Ramirez-Cuesta, A. J.; Foo, G. S.; Zhu, M.; Wachs, I. E.; Jiang, D.; Wu, Z. Elucidation of the Reaction Mechanism for High-Temperature Water Gas Shift over an Industrial-Type Copper-Chromium-Iron Oxide Catalyst. J. Am. Chem. Soc. 2019, 141, 7990-7999.
(16) Zhao, N.; He, C.; Liu, J.; Gong, H.; An, T.; Xu, H.; Zhao, F.; Hu, R.; Ma, H.; Zhang, J. Dependence of catalytic properties of Al/Fe₂O₃ thermites on morphology of Fe₂O₃ particles in combustion reactions. J. Solid State Chem. 2014, 219, 67-73.
(17) Kumar, G.; Tibbitts, L.; Newell, J.; Panthi, B.; Mukhopadhyay, A.; Rioux, R. M.; Pursell, C. J.; Janik, M.; Chandler, B. D. Evaluating differences in the active-site electronics of supported Au nanoparticle catalysts using Hammett and DFT studies. Nat. Chem. 2018, 10, 268-274.
(18) Chen, A.; Yu, X.; Zhou, Y.; Miao, S.; Li, Y.; Kuld, S.; Sehested, J.; Liu, J.; Aoki, T.; Hong, S.; Camellone, M. F.; Fabris, S.; Ning, J.; Jin, C.; Yang, C.; Nefedov, A.; Wöll, C.; Wang Y.; Shen, W. Structure of the catalytically active copper-ceria interfacial perimeter. Nat. Catal. 2019, 2, 334-341.
(19) Thompson, T. L.; Yates, J. T. Surface science studies of the photoactivation of TiO₂-New photochemical processes. Chem. Rev. 2006, 106, 4428-4453.
(20) Diebold, U. The surface science of titanium dioxide. Surf. Sci. Rep. 2002, 48, 53-229.
(21) Tsukamoto, D.; Shiraishi, Y.; Sugano, Y.; Ichikawa, S.; Tanaka, S.; Hirai, T. Gold nanoparticles located at the interface of anatase/rutile TiO₂ particles as active plasmonic photocatalysts for aerobic oxidation. J. Am. Chem. Soc. 2012, 134, 6309-6315.
(22) Matthey, D.; Wang, J. G.; Wendt, S.; Matthiesen, J.; Schaub, R.; Lægsgaard, E.; Hammer, B.; Besenbacher, F. Enhanced Bonding of Gold Nanoparticles on Oxidized TiO₂ (110). Science 2007, 315, 1692.
(23) Wang, Y.; Widmann, D.; Behm, R. J. Influence of TiO₂ Bulk Defects on CO Adsorption and CO Oxidation on Au/TiO₂: Electronic Metal-Support Interactions (EMSIs) in Supported Au Catalysts. ACS Catal. 2017, 7, 2339-2345.
(24) Qian, K.; Sweeny, B. C.; Johnston-Peck, A. C.; Niu, W.; Graham, J. O.; Duchene, J. S.; Qiu, J.; Wang, Y.; Engelhard, M. H.; Su, D.; Stach, E. A.; Wei D. W. Surface plasmon-driven water reduction: Gold nanoparticle size matters. J. Am. Chem. Soc. 2014, 136, 9842-9845.
(25) Tanaka, A.; Ogino, A.; Iwaki, M.; Hashimoto, K.; Ohnuma, A.; Amano, F.; Ohtani, B.; Kominam, H. Gold-Titanium (IV) Oxide Plasmonic Photocatalysts Prepared by a Colloid-Photodeposition Method: Correlation Between Physical Properties and Photocatalytic Activities. Langmuir 2012, 28, 13105-13111.
(26) Duchene, J. S.; Sweeny, B. C.; Johnston-Peck, A. C.; Su, D.; Stach, E. A.; Wei, W. D. Prolonged hot electron dynamics in plasmonic-metal/semiconductor heterostructures with implications for solar photocatalysis. Angew. Chemie—Int. Ed. 2014, 53, 7887-7891.
(27) He, S.; Huang, J.; Goodsell, J. L.; Angerhofer, A.; Wei, W. D. Plasmonic Nickel-TiO₂ Heterostructures for Visible-Light-Driven Photochemical Reactions. Angew. Chemie Int. Ed. 2019, 1-5.
(28) Priebe, J. B.; Radnik, J.; Lennox, A. J. J.; Pohl, M. M.; Karnahl, M.; Hollmann, D.; Grabow, K.; Bentrup, U.; Junge, H.; Beller, M.; Brückner, A. Solar Hydrogen Production by Plasmonic Au—TiO₂ Catalysts: Impact of Synthesis Protocol and TiO₂ Phase on Charge Transfer Efficiency and H₂ Evolution Rates. ACS Catal. 2015, 5, 2137-2148.
(29) Priebe, J. B.; Karnahl, M.; Junge, H.; Beller, M.; Hollmann, D.; Brückner, A. Water reduction with visible light: Synergy between optical transitions and electron transfer in Au—TiO₂ catalysts visualized by in situ EPR spectroscopy. Angew. Chemie—Int. Ed. 2013, 52, 11420-11424.
(30) Chiesa, M.; Paganini, M. C.; Livraghi, S.; Giamello, E. Charge trapping in TiO₂ polymorphs as seen by Electron Paramagnetic Resonance spectroscopy. Phys. Chem. Chem. Phys. 2013, 15, 9435-9447.
(31) Minato, T.; Susaki, T.; Shiraki, S.; Kato, H. S.; Kawai, M.; Aika, K. Investigation of the electronic interaction between TiO₂ (110) surfaces and Au clusters by PES and STM. Surf. Sci. 2004, 566-568, 1012-1017.
(32) Siemer, N.; Lüken, A.; Zalibera, M.; Frenzel, J.; Muñoz-Santiburcio, D.; Savitsky, A.; Lubitz, W.; Muhler, M.; Marx, D.; Strunk, J. Atomic-Scale Explanation of O₂ Activation at the Au—TiO₂ Interface. J. Am. Chem. Soc. 2018, 140, 18082-18092.
(33) McEntee, M.; Stevanovic, A.; Tang, W.; Neurock, M.; Yates, J. T. Electric field changes on Au nanoparticles on semiconductor supports—The molecular voltmeter and other methods to observe adsorbate-induced charge-transfer effects in Au/TiO₂ Nanocatalysts. J. Am. Chem. Soc. 2015, 137, 1972-1982.
(34) Chen, M. S.; Goodman, D. W. Catalytically active Au: from nano-particles to ultra-thin films. Acc. Chem. Res. 2006, 39, 739.
(35) Yoon, B.; Häkkinen, H.; Landman, U.; Wörz, A. S.; Antonietti, J. M.; Abbet, S.; Judai, K.; Heiz, U. Charging Effects on Bonding and Catalyzed Oxidation of CO on Au₈ Clusters on MgO. Science 2005, 307, 403-407.
(36) Green, I. X.; Tang, W.; Neurock, M.; Yates, J. T. Spectroscopic observation of dual catalytic sites during oxidation of CO on a Au/TiO₂ catalyst. Science 2011, 333, 736-739.
(37) Green, I. X.; Tang, W.; McEntee, M.; Neurock, M.; Yates, J. T. Inhibition at perimeter sites of Au/TiO₂ oxidation catalyst by reactant oxygen. J. Am. Chem. Soc. 2012, 134, 12717-12723.
(38) Rao, R. G.; Blume, R.; Hansen, T. W.; Fuentes, E.; Dreyer, K.; Moldovan, S.; Ersen, O.; Hibbitts, D. D.; Chabal, Y. J.; Schlogl, R.; Tessonnier, J. P. Interfacial charge distributions in carbon-supported palladium catalysts. Nat. Commun. 2017, 8.
(39) Zhang, S.; Plessow, P. N.; Willis, J. J.; Dai, S.; Xu, M.; Graham, G. W.; Cargnello, M.; Abild-Pedersen, F.; Pan, X. Dynamical observation and detailed description of catalysts under strong metal-support interaction. Nano Lett. 2016, 16, 4528-4534.

### Supplemental Information for Example 1

Chemicals. Commercially available P25 (Degussa) and trisodium citrate (Na₃C₆H₅O₇) were purchased from Fisher Scientific (Hampton, NH). Chloroauric acid trihydrate (HAuCl₄·3H₂O) (≥99.9% trace metals basis), sodium borohydride (NaBH₄), silica (SiO₂) supports (100-200 mesh silica gel), and ammonium hydroxide (NH₄OH) (ACS reagent, 28.0-30.0% NH3 basis) were purchased from Sigma-Aldrich (St. Louis, MO). All chemicals were used as received without further purification. All glassware was cleaned with aqua regia solution, followed by copious rinsing with Nanopure™ H₂O (Barnstead, 18.2 MΩ cm) prior to use. (CAUTION! Aqua regia is highly corrosive and toxic. Handle with care and use appropriate personal protection equipment.)

Synthesis of Au/TiO₂ Heterostructures with the Defect-Free Interface. Au/TiO₂ heterostructures with the defect-free interface were prepared using the deposition-precipitation method to grow 1 wt % and 5 wt % ca. 4-5 nm Au nanoparticles (NPs) onto commercially available P25 supports (FIG. 2.13A).¹ 1.1 g of P25 was dispersed into 100 mL of Nanopure™ H₂O under continuous sonication in a 250 mL round-bottom flask. 2.2 mL and 11 mL of a 25 mM HAuCl₄ solution was then added to achieve the desired 1 wt % and 5 wt % Au loading, respectively. The mixture was placed in an oil bath and stirred at 60° C. for 30 min. 10% NH₄OH was added dropwise to adjust its pH to 9-10, and the mixture was further stirred in the oil bath at 60° C. for another 4 h. The solid was collected via centrifugation at 10,000 RPM for 10 min, and then washed with Nanopure™ H₂O. The washing process was repeated three times, followed by drying the sample at 60° C. overnight in the oven to achieve a powder. The powder sample was finally calcined at 210° C. for 3 h in the oven to create Au/TiO₂ heterostructures. Note: the deposition-precipitation method was also utilized to deposit 1 wt % Au NPs onto SiO₂ supports to construct Au/SiO₂ heterostructures. Meanwhile, P25 employed in EPR measurements was pretreated by the deposition-precipitation method without adding HAuCl₄ solution. This pretreatment aimed to demonstrate that the observed differences in EPR spectra originated from the Au deposition.

Synthesis of Au/TiO₂ Heterostructures with the Oxygen Vacancy (Vₒ)-rich Interface. Au/TiO₂ heterostructures with the Vₒ-rich interface were prepared via several steps that were based on the previous report with modifications (FIG. 2.13B).² First, Au NPs were fabricated with a ca. 4-5 nm size via NaBH₄ reduction of HAuCl₄ in the presence of sodium citrate.³ In this process, 1 mL of 10 mM HAuCl₄ and 1 mL of 10 mM sodium citrate were added to 37 mL of Nanopure™ H₂O in a 100 ml beaker. A 1 mL aliquot of a 100 mM ice-cold NaBH₄ solution was freshly prepared and then immediately added to the previously prepared solution under the vigorous magnetic stirring. The Au NP solution reacted overnight prior to use. 4.06 mL and 8.12 mL of prepared Au NP solutions were added to the mixture of 40 mg of P25 and 80 mL of Nanopure™ H₂O to achieve the desired 0.5 wt % and 1 wt % Au loading, respectively. The mixture was stirred at room temperature for 24 h. The solid was collected via centrifugation at 10,000 RPM for 15 min and washed with Nanopure™ H₂O. This washing process was repeated three times before drying the sample at 60° C. overnight in the oven to collect the powder. The powder sample was finally calcined at 210° C. for 3 h in the oven to create Au/TiO₂ heterostructures. To achieve the interfacial reconstruction, the powder sample was further calcined at 320° C. for 3 h in the air using a tube furnace.

Electron Paramagnetic Resonance (EPR) Spectroscopy Data Collection and Analysis. EPR experiments were performed on a Bruker ELEXSYS-II E500 CW X-band spectrometer within a super high-Q cavity (ER 4123SHQE), equipped with an ESR900 Oxford Instruments helium flow cryostat for low temperature (T=90 K) experiments. For each experiment, 40±2 mg of a sample was loaded into a quartz EPR tube, capped, and placed within the microwave cavity. All spectra were collected using the following instrument parameters: 100 kHz modulation frequency, 3 G modulation amplitude, 40 ms conversion time, 15 mW microwave power, and 60 dB receiver gain. A total of 20 scans were used to acquire a signal average for each sample. The background signal measured from the pure quartz EPR tube was removed from the EPR spectra and g values used in the EPR simulation were summarized in Supplementary Table S1. Simulated EPR spectra were generated using the EasySpin toolbox in MATLAB.⁴ Note: EPR spectra of two Au/TiO₂ heterostructures in FIGS. 1.2B and 1.2C were collected when the Au loading amount was 1 wt %.

Diffuse Reflectance Infrared Fourier Transform Spectroscopy (DRIFTS) Data Collection and Analysis. DRIFTS measurements were performed on a Nicolet iS50 FTIR spectrometer equipped with a DRIFTS reaction cell (Harrick Scientific Products, Inc.) at room temperature. Prior to each measurement, 30 mg of catalysts (Au/TiO₂ heterostructures with 1 wt % Au loading) were loaded onto the sample stage of reaction cell, treated at 210° C. under He condition for 1 hour and then cooled to room temperature. The DRIFTS spectrum of freshly prepared catalyst purged with He was taken as the background spectrum. A MCT/A detector operated in series mode with 128 scans and a resolution of 2 cm⁻¹ was employed. For measurements of the vibrational mode of adsorbed carbon monoxide molecules v(CO) on Au/TiO₂ heterostructures, the spectra were collected after 1% CO/He was purged into the reaction cell at a flow rate of 20 mL min⁻¹ for 5 min. It should be noted that the spectrum collected at 5 min was similar to that obtained after 15 min, indicating that the CO adsorption and desorption on Au/TiO₂ heterostructures have reached the steady-state condition at a flow rate of 20 mL min⁻¹ for 5 min. For in operando DRIFTS measurements of v(CO) on Au/TiO₂ heterostructures during O₂ activation, the spectra were collected after 1% CO/air was purged into the reaction cell at a flow rate of 20 mL min⁻¹ for 25 min. The spectra were fitted by the XPSPEAK 4.1 software.

Room Temperature CO Oxidation Reactions. The catalytic activity was evaluated with a homemade fixed-bed flow reactor. 25 mg of catalysts were calcined at 210° C. in the oven for 1 h and then loaded into the reactor under the continuous gas flow. The reaction gas was a mixture of 1% CO/air at a flow rate of 20 mL min⁻¹. The composition of the effluent gas was analyzed every 30 min with Shimadzu gas chromatograph (GC 2014 online), using a carboxen 1000 column (Supelco, T=110° C.) and incorporating He as the carrier gas at 20 mL min⁻¹. The steady-state conversion of CO was calculated from the difference in CO concentrations between the inlet and outlet gases. Measurements were repeated three times to obtain the average value and the standard deviation. To achieve the activation barrier of CO oxidation reaction, the specific reaction rate of CO oxidation was measured under different reaction temperatures according to the following equation:

$$r ( μ mol {g}^{- 1} {s}^{- 1} ) = \frac{Δ p ( \% ) f ( \frac{mL}{min} ) c ( \frac{μ mol}{mL} )}{( 60 \frac{s}{min} ) m ( g )}$$

where Δp (%) represents the conversion percentage of CO to CO₂, f (mL/min) is the flow rate of feeding 1% CO/air, c (μmol/mL) is the initial concentration of CO before CO oxidation reaction, and m (g) is the amount of catalysts used in CO oxidation experiments.

Other Characterizations. X-ray photoelectron spectroscopy (XPS) experiments were conducted at the Major Analytical Instrumentation Center (MAIC) using a PHI 5000 VersaProbe II instrument. A focused monochromatic Al Kα X-ray source (1486.6 eV) and a spherical section analyzer were utilized. A 50 W X-ray beam was focused to a 200 μm diameter spot size incident normal to the sample with the photoelectron detector at 45° off-normal. The binding energy of adventitious carbon at 284.8 eV was used as a reference to correct for any specimen charging effects for all XPS spectra. The resolution of XPS spectra was 0.1 eV. Note: XPS spectra of two Au/TiO₂ heterostructures in FIG. 1.2A were collected when the Au loading amount was 1 wt %. Transmission electron microscopy (TEM) and high-resolution TEM (HRTEM) were conducted on a JEOL 2010F HRTEM operated at 200 kV, located at MAIC at the University of Florida (UF).

Numerical Simulations. Theoretical calculations were carried out using density functional theory (DFT) calculations via Quantum Espresso (v.6.2).^{5,6} The generalized gradient approximation with PBE functional was used to describe the exchange-correlation energy.⁷ Valence electrons were described using Kohn-Sham single-electron wave functions by a plane-wave basis set with an energy cut-off of 400 eV. The DFT+U method with U_{eff} at 4.0 eV was applied to 3d orbitals of Ti to correct on-site Coulomb interactions.^{8,9} Au/TiO₂ heterostructures were constructed by depositing a periodic three-layers Au rod onto a periodic three layers of rutile TiO₂ (110) slab along the TiO₂ [110̅] direction. The interfacial layer has the structure of Au (111) surface. For Au/TiO₂ heterostructures with the defect-free interface, one of the interfacial oxygen atoms on TiO₂ was substituted by a Au atom to represent the diffusion of Au atoms into surface Vₒ on TiO₂, while this oxygen atom was removed without adding a Au atom for the Vₒ-rich Au/TiO₂ interface. An O₂ molecule was added at the perimeter of Au/TiO₂ heterostructures. Structure optimizations were obtained until the force converged to less than 0.01 eV Å⁻¹ at each atomic position. Relaxed structures were visualized by VESTA.¹⁰ A Bader analysis was employed to determine the local charge of atoms in the system.^{11,12}

Previous studies have shown that using the adventitious carbon (284.8 eV) as a reference, the binding energy of the C 1s for COO—Au (i.e., the chemical bond between adsorbed citrate ions and Au) was located at 287.6 eV.¹⁴ However, as shown in our XPS spectrum, we did not observe any feature at the binding energy of 287.6 eV for Au/TiO₂ heterostructures with the Vₒ-rich interface, confirming that no citrate ions remained on Au surfaces for Au/TiO₂ heterostructures prepared by the CD method.

Compared to the reported v(CO) at 2117 cm⁻¹ on Au/SiO₂ NPs,¹⁷ both v(CO) for Au/TiO₂ heterostructures with the defect-free interface at 2103 cm⁻¹ and v(CO) for Au/TiO₂ heterostructures with the Vₒ-rich interface at 2107 cm⁻¹ revealed that supported Au NPs on TiO₂ were negatively charged. In addition, a stronger red-shift of v(CO) on the defect-free interface as compared to that on the Vₒ-rich interface suggested that Au NPs on the defect-free interface were more electron-rich than those on the Vₒ-rich interface. These consistent results between DRIFTS and XPS measurements (FIG. 1.2A) demonstrated that CO was suitable to function as a molecular probe for detecting subtle variations in the surface electron density of Au NPs during O₂ activation in operando.

It is known that the full-width half maximum (FWHM) of vibrational signature in DRIFTS is determined by the lifetime of vibrationally excited sates (Equation (1)). 18 When CO molecules chemisorb on the metal surface (e.g., Cu (110)), a commonly accepted damping mechanism that governs the lifetime of CO vibrationally excited state is the charge oscillation between adsorbed CO molecules and metal.^{19,20} In detail, upon chemisorption of CO molecules onto the metal surface, electrons originated from metal are back-donated into 2π* orbital of adsorbed CO molecules, increasing the charge oscillation between molecular orbitals of adsorbed CO and metal. Since the charge oscillation can not occur adiabatically, energy is eventually lost through the excitation of electron-hole pairs in the metal, leading to the vibrational damping of CO molecules. Equation (2) is accordingly derived to explain the relationship between the lifetime of vibrational excitation of CO molecules and the magnitude of charge oscillations between adsorbed CO molecules and metal.¹⁹⁻²¹ Since more electrons were back-donated from Au NPs into 2π* orbitals of adsorbed CO molecules on Au/TiO₂ heterostructures with the defect-free interface, the value of charge oscillation (on) between molecular orbitals of adsorbed CO and Au NPs was larger than that on Au/TiO₂ heterostructures with the Vₒ-rich interface. As a result, according to Equation (1) and (2), a broader FWHM of CO vibrational signature was observed on the defect-free interface as compared to that of CO vibrational signature on the Vₒ-rich interface.

$$δ {v}_{n} = {( 2 π {T}_{i} )}^{- 1} or {δω}_{nb} 6 {ω}_{n} = 1 / {T}_{i} \qquad ( 1 )$$

where δvₙ and δωₙ represent FWHM in terms of angular frequency, and τᵢ is the lifetime of vibrational excitation in molecules.

$$1 / {T}_{i} ∝ 2 π Ω {( δ n )}^{2} \qquad ( 2 )$$

where Ω is the vibration frequency and δn is the magnitude of charge oscillation between molecular orbitals of adsorbed CO and metal.

TABLE S1
Summary of g values used for simulation
of X-band EPR spectra at 90K.

| Signal Assignment | Average gₓ | Average g_{y} | Average g_{z} |
|---|---|---|---|
| e⁻(Vₒ) | 2.003 | 2.003 | 2.003 |
| Ti³⁺(Rutile) | 1.978 | 1.978 | 1.962 |
| Ti³⁺(Anatase) | 1.991 | 1.991 | 1.950 |

### REFERENCES FOR SUPPLEMENTARY INFORMATION

(1) Qian, K.; Sweeny, B. C.; Johnston-Peck, A. C.; Niu, W.; Graham, J. O.; Duchene, J. S.; Qiu, J.; Wang, Y.; Engelhard, M. H.; Su, D.; Stach, E. A.; Wei D. W. Surface plasmon-driven water reduction: Gold nanoparticle size matters. J. Am. Chem. Soc. 2014, 136, 9842-9845.
(2) Tanaka, A.; Ogino, A.; Iwaki, M.; Hashimoto, K.; Ohnuma, A.; Amano, F.; Ohtani, B.; Kominami, H. Gold-Titanium (IV) Oxide Plasmonic Photocatalysts Prepared by a Colloid-Photodeposition Method: Correlation Between Physical Properties and Photocatalytic Activities. Langmuir 2012, 28, 13105-13111.
(3) DuChene, J. S.; Niu, W.; Abendroth, J. M.; Sun, Q.; Zhao, W.; Huo, F.; Wei, D. W. Halide anions as shape-directing agents for obtaining high-quality anisotropic gold nanostructures. Chem. Mater. 2013, 25, 1392-1399.
(4) Stoll, S.; Schweiger, A. EasySpin, a comprehensive software package for spectral simulation and analysis in EPR. J. Magn. Reson. 2006, 178, 42-55.
(5) Giannozzi, P.; Andreussi, O.; Brumme, T.; Bunau, O.; Nardelli, M. B.; Calandra, M.; Car, R.; Cavazzoni, C.; Ceresoli, D.; Cococcioni, M.; Colonna, N.; Carnimeo, I.; Corso, A. D.; Gironcoli, S. D.; Delugas, P.; DiStasio Jr, R. A.; Ferretti, A.; Floris, A.; Fratesi, G.; Fugallo, G.; Gebauer, R.; Gerstmann, U.; Giustino, F.; Gorni, T.; Jia, J.; Kawamura, M.; Ko, H. Y.; Kokalj, A.; Küçükbenli, E.; Lazzeri, M.; Marsili, M.; Marzari, N.; Mauri, F.; Nguyen, N. L.; Nguyen, H. V.; Otero-de-la-Roza, A.; Paulatto, L.; Poncé, S.; Rocca, D.; Sabatini, R.; Santra, B.; Schlipf, M.; Seitsonen, A. P.; Smogunov, A.; Timrov, I.; Thonhauser, T.; Umari, P.; Vast, N.; Wu, X.; Baroni, S. Advanced capabilities for materials modelling with Quantum ESPRESSO. J. Phys. Condens. Matter 2017, 29, 465901.
(6) Giannozzi, P.; Baroni, S.; Bonini, N.; Calandra, M.; Car, R.; Cavazzoni, C.; Ceresoli, D.; Chiarotti, G. L.; Cococcioni, M.; Dabo, I.; Corso, A. D.; Gironcoli, S. D.; Fabris, S.; Fratesi, G.; Gebauer, R.; Gerstmann, U.; Gougoussis, C.; Kokalj, A.; Lazzeri, M.; Martin-Samos, L.; Marzari, N.; Mauri, F.; Mazzarello, R.; Paolini, S.; Pasquarello, A.; Paulatto, L.; Sbraccia, C.; Scandolo, S.; Sclauzero, G.; Seitsonen, A. P.; Smogunov, A.; Umari, P.; Wentzcovitch, R. W. QUANTUM ESPRESSO: A modular and open-source software project for quantum simulations of materials. J. Phys. Condens. Matter 2009, 21, 395502.
(7) Perdew, J. P.; Burke, K.; Ernzerhof, M. Generalized gradient approximation made simple. Phys. Rev. Lett. 1996, 77, 3865.
(8) Finazzi, E.; Di Valentin, C.; Pacchioni, G.; Selloni, A. Excess electron states in reduced bulk anatase TiO₂: Comparison of standard GGA, GGA+U, and hybrid DFT calculations. J. Chem. Phys. 2008, 129.
(9) Morgan, B. J.; Watson, G. W. A DFT+U description of oxygen vacancies at the TiO₂ rutile
(1 1 0) surface. Surf. Sci. 2007, 601, 5034-5041.
(10) Momma, K.; Izumi, F. VESTA 3 for three-dimensional visualization of crystal, volumetric and morphology data. J. Appl. Crystallogr. 2011, 44, 1272-1276.
(11) Tang, W.; Sanville, E.; Henkelman, G. A grid-based Bader analysis algorithm without lattice bias. J. Phys. Condens. Matter 2009, 21.
(12) Henkelman, G.; Arnaldsson, A.; Jónsson, H. A fast and robust algorithm for Bader decomposition of charge density. Comput. Mater. Sci. 2006, 36, 354-360.
(13) Priebe, J. B.; Radnik, J.; Lennox, A. J. J.; Pohl, M. M.; Karnahl, M.; Hollmann, D.; Grabow, K.; Bentrup, U.; Junge, H.; Beller, M.; Brückner, A. Solar Hydrogen Production by Plasmonic Au—TiO₂ Catalysts: Impact of Synthesis Protocol and TiO₂ Phase on Charge Transfer Efficiency and H₂ Evolution Rates. ACS Catal. 2015, 5, 2137-2148.
(14) Park, J. W.; Shumaker-Parry, J. S. Structural study of citrate layers on gold nanoparticles: role of intermolecular interactions in stabilizing nanoparticles. J. Am. Chem. Soc. 2014, 136, 1907-1921.
(15) Priebe, J. B.; Karnahl, M.; Junge, H.; Beller, M.; Hollmann, D.; Brückner, A. Water reduction with visible light: Synergy between optical transitions and electron transfer in Au—TiO₂ catalysts visualized by in situ EPR spectroscopy. Angew. Chemie—Int. Ed. 2013, 52, 11420-11424.
(16) Chiesa, M.; Paganini, M. C.; Livraghi, S.; Giamello, E. Charge trapping in TiO₂ polymorphs as seen by Electron Paramagnetic Resonance spectroscopy. Phys. Chem. Chem. Phys. 2013, 15, 9435-9447.
(17) Qian, K.; Luo, L.; Bao, H.; Hua, Q.; Jiang, Z.; Huang, W. Catalytically active structures of SiO₂-supported Au nanoparticles in low-temperature CO oxidation. Catal. Sci. Technol. 2013, 3, 679-687.
(18) Demtröder W. Laser spectroscopy 1: basic principles. Ed. 4 74-111 (Springer, 2014).
(19) Ryberg, R. Carbon monoxide adsorbed on Cu (100) Studied by infrared spectroscopy. Surf. Sci. 1982, 114, 627-641.
(20) Persson, B. N. J.; Ryberg, R. Vibrational interaction between molecules adsorbed on a metal surface: The dipole-dipole interaction. Phys. Rev. B 1981, 24, 6954-6970.
(21) Persson, B. N. J.; Persson, M. Vibrational lifetime for CO adsorbed on Cu (100). Solid State Commun. 1980, 36, 175-179.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. In an embodiment, the term “about” can include traditional rounding according to significant figures of the numerical value. In addition, the phrase “about ‘x’ to ‘y’” includes “about ‘x’ to about ‘y’”.

It should be emphasized that the above-described embodiments of the present disclosure are merely possible examples of implementations, and are set forth only for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure.

1. A composition, comprising: a M/TiO₂ composite having a defect-free M/TiO₂ interface, wherein the M/TiO₂ composite has the characteristic of having a higher CO oxidation activity than that on the oxygen vacancy (Vₒ)-rich M/TiO₂ interface.

2. The composition of claim 1, wherein the Mis Au, Ag, Al, Cu, Pt, Ni, or Pd.

3. The composition of claim 1, wherein the M/TiO₂ composite is a Au/TiO₂ composite.

4. The composition of claim 3, wherein the Au/TiO₂ composite has the characteristic of having at least a 15 times higher CO oxidation activity than that on the oxygen vacancy (Vₒ)-rich Au/TiO₂ interface.

5. The composition of claim 3, wherein the Au/TiO₂ composite has the characteristic of having at least a 25 times higher CO oxidation activity than that on the oxygen vacancy (Vₒ)-rich Au/TiO₂ interface.

6. The composition of claim 1, wherein the M/TiO₂ composite is a Cu/TiO₂ composite.

7. The composition of claim 1, wherein the M is Au or Cu.

8. The composition of claim 1, wherein the M is Ag, Al, Pt, Ni, or Pd.

9. The composition of claim 1, wherein the M/TiO₂ composite has a longest dimension of about 10 to 50 nm,

10. The composition of claim 1, wherein the M/TiO₂ composite has a longest dimension of about 23 to 27 nm.
